(19) United States
(12) Patent Application Publication
(10) Pub. No.: US 2019/0228713 A1
(43) Pub. Date: Jul. 25, 2019

(54) DISPLAY DEVICE AND ELECTRONIC APPARATUS

(71) Applicant: SEIKO EPSON CORPORATION, Tokyo (JP)

(72) Inventors: Tsuyoshi TAMURA, Suwa-gun (JP); Hitoshi OTA, Shiojiri-shi (JP); Robina ATSUCHI, Chino-shi (JP)

(73) Assignee: SEIKO EPSON CORPORATION, Tokyo (JP)

(21) Appl. No.: 16/256,572

(22) Filed: Jan. 24, 2019

(30) Foreign Application Priority Data
Jan. 25, 2018 (JP) 2018-010419

(51) Int. Cl. G09G 3/3275; G09G 3/3266; G09G 3/3225

(52) U.S. Cl. CPC G09G 3/3275; G09G 3/3266; G09G 2300/0842; G09G 2330/021; G09G 3/3225

(57) ABSTRACT

A display device includes a display unit including pixel circuits disposed corresponding to each intersection of plurality of scanning lines and a plurality of data transfer lines that includes a first data transfer line, a second data transfer line, and a third data transfer line, and a driving circuit configured to select the plurality of scanning lines and apply a gradation signal to the plurality of data transfer lines. The second and third data transfer lines are connected to each other.

### BACKGROUND

### 1. Technical Field

The invention relates to a display device and an electronic apparatus.

### 2. Related Art

A display device including a display panel in which pixel circuits including a light-emitting element such as an Organic Light-emitting Diode (OLED), transistors, and the like, are arranged in a matrix corresponding to the positions of pixels where scanning lines and data transfer lines intersect with each other has been widespread.

JP-A-5-108036 discloses a display device including a plurality of display regions having different resolutions, wherein the display region closer to a central portion has higher resolution.

JP-A-5-108036 does not describe a specific configuration for increasing the resolution of the display region closer to the central portion. As a general method for raising the resolution of the display panel, there is a method of increasing the number of the pixel circuits arranged in the display panel. However, there is a problem that, when the number of the pixel circuits arranged in the display panel is increased, the circuit scale of the driving circuit for driving the pixel circuits is increased according to the increment of the number of pixel circuits. Further, there is a problem that power consumption increases as the circuit scale of the driving circuit becomes larger.

### SUMMARY

In order to solve the problems described above, an aspect of a display device according to the invention is a display device including a display unit including pixel circuits disposed corresponding to each intersection of a plurality of scanning lines and a plurality of data transfer lines including a first data transfer line, a second data transfer line, and a third data transfer line, and a driving circuit that selects the plurality of scanning lines and applies a gradation signal indicating a display gradation to the first, second and third data transfer lines, wherein the second and third data transfer lines are connected to each other, the driving circuit applies the same gradation signal to the second and third data transfer lines, and a pixel circuit at a center of the display unit is disposed corresponding to the first data transfer line.

According to this aspect, for the second data transfer line and the third data transfer line that are applied with the same gradation signal, since only one output unit of the gradation signal has to be disposed in the driving circuit, as compared with an aspect in which the output units are disposed for each of all the data transfer lines, the configuration of the driving circuit is simplified, and power consumption can be reduced while an increase in the circuit scale of the driving circuit is suppressed.

The pixel circuit to which the same gradation signal is supplied via the second data transfer line and the third data transfer line display the same gradation, thus the resolution decreases. On the other hand, another gradation signal is applied to the first data transfer line, thus the resolution in a scanning line direction, that is, a horizontal resolution is high. Therefore, a high resolution display region and a low resolution display region are mixed in the display unit. In this aspect, the pixel circuit at the center of the display unit is disposed corresponding to the first data transfer line, thus the resolution at the center of the display unit can be increased. As the visual characteristics of human, the sensitivity to resolution in a line of sight direction is high, and the sensitivity to resolution of the peripheral region is low. When the display device of this aspect is applied to a head-mounted display and the like, the resolution perceived by the user is the resolution at the center of the display unit. Therefore, according to this aspect, the driving circuit can be simplified, meanwhile, an image having a substantially high resolution in the scanning line direction can be displayed.

In the display device described above, the display region of the display unit is divided into a plurality of display regions including a first display region and a second display region in a wiring direction of the first data transfer line, the first display region includes first scanning lines of the plurality of scanning lines, and the second display region includes second scanning lines of the plurality of scanning lines, and during a period required for displaying an image for one screen, the driving circuit selects the first scanning lines one by one for the first display region and selects the second scanning lines every other line or every other plural lines for the second display region.

According to this aspect, the rewriting period of the display gradation of the pixel circuit belonging to the second display region is longer than the rewriting period of the display gradation of the pixel circuit belonging to the first display region, and the apparent resolution considering the resolution in a time axis direction is lower in the second display region than in the first display region. Further, according to this aspect, as compared with an aspect in which the display gradation of the pixel circuit belonging to the first display region and the display gradation of the pixel circuit belonging to the second display region are rewritten at the same period, the power consumption is reduced.

In the display device described above, the display region of the display unit is divided into a plurality of display regions including a first display region and a second display region in the wiring direction of the first data transfer line, the first display region includes first scanning lines of the plurality of scanning lines, and the second display region includes second scanning lines of the plurality of scanning lines, and during a period required for displaying an image for one screen, the driving circuit selects the first scanning lines one by one for the first display region and selects a plurality of the second scanning lines at a time for the second display region.

According to this aspect, the resolution of the second display region is lower than the resolution of the first display region. Further, according to this aspect, an increase in the circuit scale of the driving circuit can be further suppressed.

In the display device described above, the pixel circuit at the center of the display unit may belong to the first display region.

According to this aspect, the first display region is located at the center of the display unit, thus at the center of the display unit, the resolution in the direction of the first data transfer line, that is, the vertical resolution can be increased. Therefore, the driving circuit can be simplified, meanwhile, an image having a high resolution in the first data transfer line direction can be displayed.

Another aspect of the display device according to the invention is a display device including a display unit that includes pixel circuits disposed corresponding to each intersection of a plurality of scanning lines and data transfer lines, and is divided into a plurality of display regions including a first display region and a second display region in a wiring direction of the data transfer line, the first display region includes first scanning lines of the plurality of scanning lines, and the second display region includes second scanning lines of the plurality of scanning lines, and a driving circuit that, during a period required for displaying an image for one screen, selects the first scanning lines one by one for the first display region, and selects the second scanning lines every other line or every other plural lines for the second display region, and applies a gradation signal indicating a display gradation to the data transfer lines, wherein a pixel circuit at a center of the display unit belongs to the first display region.

According to this aspect, the second scanning lines are selected every other line or every other plural lines for the second display region, thus, as compared with an aspect in which all the second scanning lines in the second display region are selected, the configuration of the driving circuit is simplified, and the power consumption can be reduced while an increase in the circuit scale of the driving circuit is suppressed. Further, the first display region is located at the center of the display unit, thus at the center of the display unit, the resolution in the direction of the data transfer line, that is, the vertical resolution can be increased. Therefore, the driving circuit can be simplified, meanwhile, an image having a substantially high resolution in the data transfer line direction can be displayed.

Another aspect of the display device according to the invention is a display device including a display unit that includes pixel circuits disposed corresponding to each intersection of a plurality of scanning lines and data transfer lines, and is divided into a plurality of display regions including a first display region and a second display region in a wiring direction of the data transfer line, and a driving circuit, during a period required for displaying an image for one screen, selects the first scanning lines one by one for the first display region, and selects the second scanning lines at a time for the second display region, and applies a gradation signal indicating a display gradation to the data transfer lines, wherein a pixel circuit at a center of the display unit belongs to the first display region.

According to this aspect, second scanning lines are selected at a time for the second display region, thus, as compared with the aspect in which all the second scanning lines in the second display region are selected, the configuration of the driving circuit is simplified, and the power consumption can be reduced while an increase in the circuit scale of the driving circuit is suppressed. Further, the first display region is located at the center of the display unit, thus at the center of the display unit, the resolution in the direction of the data transfer line, that is, the vertical resolution can be increased. Therefore, the driving circuit can be simplified, meanwhile, an image having a substantially high resolution in the data transfer line direction can be displayed.

In the display device described above, each of the pixel circuits may include a light-emitting element having the same size.

As a method of making the resolution of any one of the plurality of display regions higher than the resolution of the other display region, it is conceivable to make the sizes of the light-emitting elements included in the pixel circuits different between the display regions.

Specifically, it is conceivable that, in the display region for increasing the resolution, pixel circuits including light-emitting elements smaller than light-emitting elements included in pixel circuits arranged in other display regions are arranged at a higher density than other display regions. However, in a display device with an OLED and the like being used as a light-emitting element, the brightness of the pixel depends on the size of the light-emitting element.
Therefore, in an attempt to adjust the resolution of each display region by making the sizes of the light-emitting elements of the pixel circuits different between the display regions, it is necessary to correct the brightness between the display regions. However, there are individual differences in the pixel circuits, thus it is very difficult to correct the brightness between the display regions. According to this aspect, the sizes of the light-emitting elements included in each of the pixel circuits are the same. Therefore, according to this aspect, it is not necessary to correct the brightness caused by the sizes of the light-emitting elements between the display regions.

In addition to the display device, the invention can be conceptualized as an electronic apparatus including the display device. The electronic apparatus typically includes a head-mounted display (HMD), an electronic viewfinder, and the like.

### BRIEF DESCRIPTION OF THE DRAWINGS

The invention will be described with reference to the accompanying drawings, wherein like numbers reference like elements.

FIG. 1 is a perspective view illustrating a configuration of a display device 1 according to First Exemplary Embodiment of the invention.

FIG. 2 is a diagram illustrating a configuration of a display panel 10 included in the display device 1.

FIG. 3 is a diagram illustrating a configuration example of a scanning line driving circuit 200.

FIG. 4 is a diagram illustrating a configuration example of a first data transfer line driving circuit 500A and a second data transfer line driving circuit 500B.

FIG. 5 is a diagram for explaining display regions A11 to A33 included in the display unit 100.

FIG. 6 is a diagram illustrating an operation example of the display device 1.

FIG. 7 is a diagram illustrating the operation example of the display device 1.

FIG. 8 is a diagram illustrating an example of visual field characteristics of human eye.

FIG. 9 is a diagram for explaining the configuration of a display device 1A according to Second Exemplary Embodiment of the invention.

FIG. 10 is a diagram for explaining an operation of the display device 1A.

FIG. 11 is a diagram for explaining the operation of the display device 1A.

FIG. 12 is a diagram illustrating a configuration example of a pixel circuit 110 included in the display device 1A.

FIG. 13 is a diagram for explaining Vth compensation in the display device 1A.

FIG. 14 is a diagram for explaining a display device according to Modification Example (2).

FIG. 15 is a diagram for explaining the display device according to Modification Example (2).

FIG. 16 is a diagram for explaining an electro-optical apparatus according to Modification Example (3).

FIG. 17 is a perspective view of a head-mounted display 300 according to the invention.

### DESCRIPTION OF EXEMPLARY EMBODIMENTS

Hereinafter, exemplary embodiments for carrying out the invention will be described with reference to accompanying drawings. However, in each drawing, a size and scale of each unit is different from the actual size and scale of each unit as appropriate. In addition, exemplary embodiments described below are desirable specific examples of the invention, and various technically appropriate preferred limitations are applied, but the scope of the invention is not limited to these exemplary embodiments unless a description to the effect that the disclosure is specifically limited is made in the explanation below.

### A. First Exemplary Embodiment

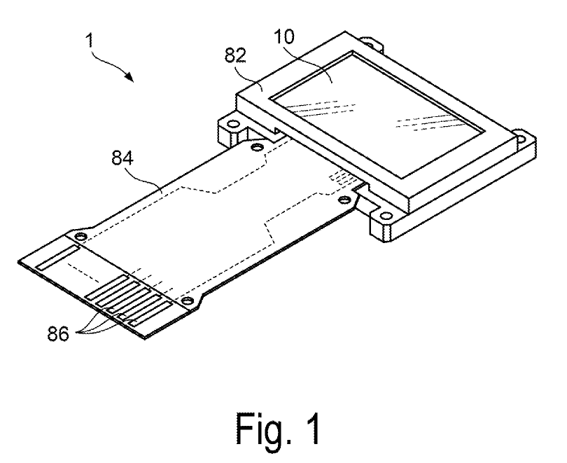

FIG. 1 is a perspective view illustrating a configuration of a display device 1 according to an exemplary embodiment of the invention. A display device 1 is, for example, a micro display that displays an image on a head-mounted display.

As illustrated in FIG. 1, the display device 1 includes a display panel 10. The display panel 10 includes a plurality of pixel circuits, a driving circuit for driving the pixel circuits, and a control circuit for controlling the operation of the driving circuit. In the present exemplary embodiment, the plurality of the pixel circuits, the driving circuit, and the control circuit included in the display panel 10 are formed on a silicon substrate, and an OLED which is an example of an electro-optical element is used as a light-emitting element in the pixel circuit. Further, for example, the display panel 10 is housed in a frame-shaped case 82 opened at the display unit, while being connected with one end of a Flexible Printed Circuit (FPC) substrate 84.

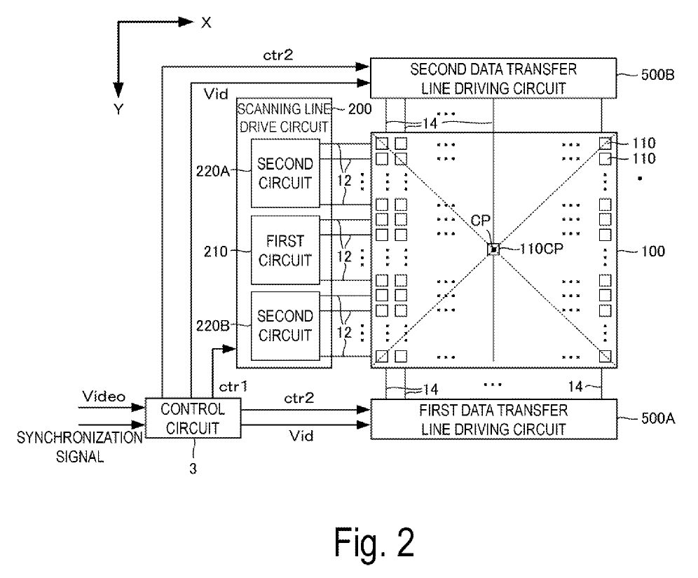

FIG. 2 is a block diagram illustrating a configuration of the display panel 10 according to the exemplary embodiment. The display panel 10 includes the control circuit 3. To the control circuit 3, digital image data Video is supplied from the upper circuit (not illustrated) synchronously with a synchronizing signal. Here, the image data Video is data defining a display gradation of pixels of an image to be displayed on the display panel 10, for example, with 8 bits. Based on the image data Video, display gradations of a plurality of pixels disposed in the display unit 100 described later are determined. Further, the synchronization signal is a signal including vertical synchronization signal, horizontal synchronization signal, and dot clock signal.

The control circuit 3 generates various control signals based on the synchronization signal and supplies the control signals to the driving circuit. The driving circuit includes a scanning line driving circuit 220B, a first data transfer line driving circuit 500A, and a second data transfer line driving 500B. This is supplied to the driving circuit. Specifically, the control circuit 3 supplies control signals Ctr1 to Ctr2 to the driving circuit. Each of the control signals Ctr1 to Ctr2 is a signal including a plurality of signals such as a pulse signal, a clock signal, and an enable signal. Further, the control circuit 3 generates an analog image signal Vid based on the image data Video. Specifically, the control circuit 3 is provided with a look-up table in which the potential indicated by the image signal Vid and the luminance of the electro-optical element included in the display panel 10 are stored in association with each other. By referring the look-up table, the control circuit 3 generates the image signal Vid illustrating the potential corresponding to the luminance of the electro-optical element defined by the image data Video, and supplies the image signal Vid to the first data transfer line driving circuit 500A and the second data transfer line driving circuit 500B.

In the present exemplary embodiment, the driving circuit is divided into the scanning line driving circuit 200, the first data transfer line driving circuit 500A, and the second data transfer line driving circuit 500B, but these may be integrated into one circuit to configure a driving circuit. In the display unit 100, pixel circuits 110 corresponding to pixels of an image to be displayed are arranged in a matrix. Although detailed illustration is omitted in FIG. 2, the display unit 100 is provided with M rows of scanning lines 12 extending in the horizontal direction in the figure and 3N columns of data transfer lines 14 grouped in every three columns extending in the vertical direction in the figure. The horizontal direction is the X direction illustrated in FIG. 2, and the vertical direction is the Y direction illustrated in FIG. 2.

Each of the scanning lines 12 and each of the data transfer lines 14 are electrically insulated from each other. The pixel circuits 110 are disposed corresponding to the intersections of the M rows of scanning lines 12 and the 3N columns of data transfer lines 14. In the present exemplary embodiment, the pixel circuits 110 are arranged in a matrix with M vertical rows×3N horizontal columns. In the present exemplary embodiment, all of M×3N of the pixel circuits 110 include light-emitting elements having the same size. Further, in the present exemplary embodiment, the display unit 100 has a so-called 3K 3K resolution, specifically, N=2880, and M=3240. The vertical scanning frequency of the display unit 100 is 90 Hz.

Here, each of M and N is a natural number. In order to distinguish the rows of the scanning lines 12 from the rows of the matrix of the pixel circuits 110, the rows of the scanning lines 12 may be sequentially referred to as 1, 2, 3, . . . , M−1, and M row from the top in the figure. Similarly, to distinguish the columns of the data transfer lines 14 from the columns of the matrix of the pixel circuits 110, the columns of the data transfer lines 14 may be sequentially referred to as 1, 2, 3, . . . , 3N−1, and 3N column from the left in the figure. Here, in order to generalize and explain the group of the data transfer lines 14, an arbitrary integer greater than or equal to 1 is represented by n, the data transfer lines 14 in the (3n−2)-th column, the (3n−1)-th column, and the 3n-th column belonging to the n-th group counting from the left. The three pixel circuits 110 corresponding to the scanning line 12 of the same row and three columns of the data transfer lines 14 belonging to the same group respectively correspond to R (red), G (green), and B (blue) pixels, and these three pixels represent one dot of a color image to be displayed. That is, in the present exemplary embodiment, the color of one dot is configured to be represented by additive color mixture by light emission of the OLED corresponding to RGB.

A pixel circuit 110 with an emission color of R is disposed corresponding to the intersection of the (3n−2)-th (n=1 to N) data transfer line 14 from the left side of the display unit 100 and the m-th (m=1 to M) scanning line 12 from the upper side of the display unit 100. The pixel circuit 110 with the emission color of R is referred to as a pixel circuit 110R. A pixel circuit 110 with an emission color of G is disposed corresponding to the intersection of the (3n−1)-th (n=1 to N) data transfer line 14 from the left side of the display unit 100 and the m-th (m=1 to M) scanning line 12 from the upper side of the display unit 100. The pixel circuit 110 with the emission color of G is referred to as a pixel circuit 110G. A pixel circuit 110 with an emission color of B is disposed corresponding to the intersection of the 3n-th (n=1 to N) data transfer line 14 from the left side of the display unit 100 and the m-th (m=1 to M) scanning line 12 from the upper side of the display unit 100. The pixel circuit 110 with the emission color of B is referred to as a pixel circuit 110B. Further, the pixel circuit 110 located at the center CP of the display unit 100 is referred to as a pixel circuit 110CP. The center CP of the display unit 100 is located at an intersection of the diagonal lines of the display region of the display unit 100. The pixel circuit 110CP corresponds to the pixel circuit 110 at the center of the display unit 100.

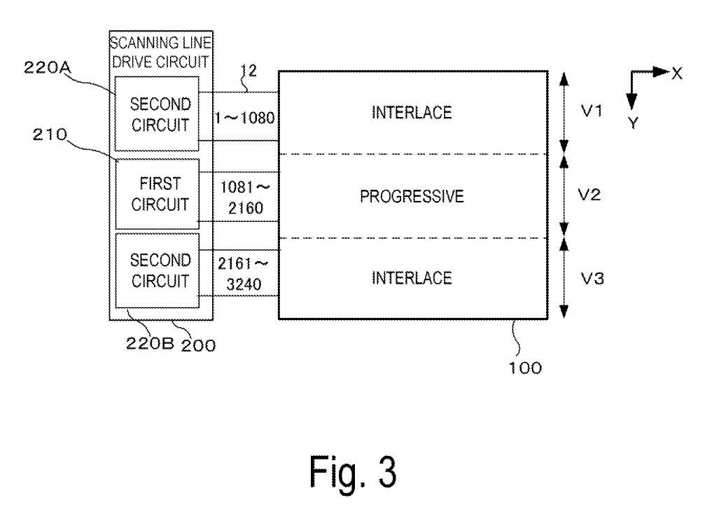

The scanning line driving circuit 200 generates a scanning signal that sequentially selects the scanning lines 12 of M rows in accordance with the control signal Ctr1 during one frame period. That is, the scanning line driving circuit 200 is a circuit that selects the scanning lines 12 of M rows. The frame period is a period required for the display device 1 to display an image of one screen. For example, in a case where the frequency of the vertical synchronization signal included in the synchronization signal is 90 Hz, the period of 11.1 ms for one cycle is the frame period. As illustrated in FIG. 2, the scanning line driving circuit 200 includes a first circuit 210 and second circuits 220A and 220B. As illustrated in FIG. 3, in the first circuit 210, 1080 scanning lines 12 from the top 1081th to 2160th among the 3240 scanning lines 12 are connected. In the second circuit 220A, 1080 scanning lines 12 from the top 1st to 1080th among the 3240 scanning lines 12 are connected, and 1080 scanning lines 12 from the top 2161th to 3240th among the 3240 scanning lines 12 are connected in the second circuit 220B.

The second circuit 220A is a circuit that sequentially selects the 1st to 1080th scanning lines 12 every other line in order from the top during one frame period, and the second circuit 220B is a circuit that sequentially selects the 2161th to 3240th the scanning lines 12 every other line in order from the top during one frame period. For example, each of the second circuit 220A and the second circuit 220B selects the odd-numbered scanning lines 12 during the k-th (k is an arbitrary integer greater than or equal to one) frame period, and selects the even-numbered scanning lines 12 during the (k+1)-th frame period. On the other hand, during one frame period, the first circuit 210 sequentially selects each of the 1080th to 2160th scanning lines 12 one by one from the top. As illustrated in FIG. 3, the display region of the display unit 100 is divided into three display regions V1, V2, and V3 in the Y direction. During one frame period, the scanning line driving circuit 200 performs interlace driving of the pixel circuits 110 belonging to the display region V1, then performs progressive driving of the pixel circuits 110 belonging to the display region V2, and then performs interlace driving of the pixel circuits 110 belonging to the display region V3. In the present example, the display region V2 corresponds to a first display region for selecting the scanning line 12 one by one, and the display regions V1 and V3 correspond to a second display region for selecting scanning line 12 every other line.

The first data transfer line driving circuit 500A and the second data transfer line driving circuit 500B illustrated in FIG. 2 generate gradation signals applied to each of the N data transfer lines 14 based on the image signal Vid and the control signal Ctr2. Note that, the gradation signal in this example is applied in the form of a voltage. The first data transfer line driving circuit 500A generates a gradation signal applied to half of the pixel circuit 110B and all of the pixel circuits 110R among the M×3N pixel circuits 110 included in the display unit 100, and the second data transfer line driving circuit 500B generates a gradation signal applied to the remaining half of the pixel circuit 110B and all of the pixel circuits 110G in the M×3N pixel circuits 110 included in the display unit 100.

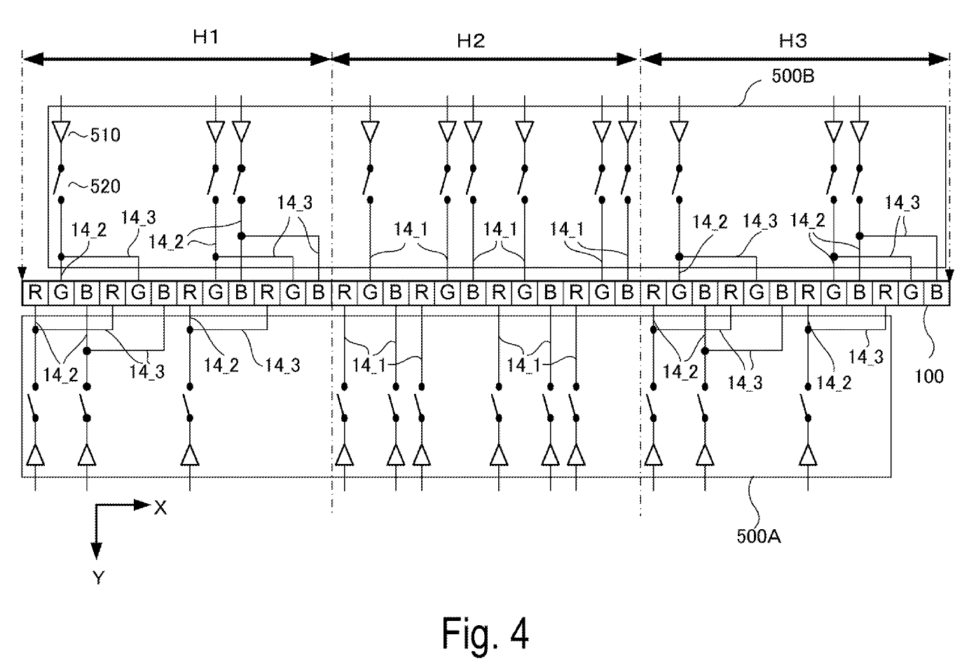

FIG. 4 is a diagram illustrating a connection relationship between the first data transfer line driving circuit 500A and the second data transfer line driving circuit 500B, and the pixel circuit 110. In FIG. 4, each of the pixel circuits is indicated by one alphabetical letter, wherein the pixel circuit 110R is indicated by “R”, the pixel circuit 110G is indicated by “G”, and the pixel circuit 110B is indicated by “B”. In FIG. 4, in order to simplify the notation, the display unit 100 is represented by a single column of pixel circuits 110, but the actual display unit 100 includes M columns of pixel circuits 110. Further, the number of pixel circuits 110 per column of the display unit 100 is 36, the actual display unit 100 includes the pixel circuits 110 of 3N rows.

Data transfer lines 14_1 illustrated in the figure is connected to the central pixel circuits 110CP. In other words, the central pixel circuits 110 CP are disposed corresponding to the data transfer lines 14_1, which is an example of the first data transfer lines. Further, as illustrated in FIG. 4, the first data transfer line driving circuit 500A and the second data transfer line driving circuit 500B include switches 520 that switch connection/disconnection between the amplifiers 510 for amplifying the gradation signal and the data transfer lines 14. The number of amplifiers 510 included in each of the first data transfer line driving circuit 500A and the second data transfer line driving circuit 500B is smaller than the number of data transfer lines 14 connected to each of the first data transfer line driving circuit 500A and the second data transfer line driving circuit 500B. Note that, the switches 520 are turned on in normal operation. Although details will be described below, in the present exemplary embodiment, the operation time of the amplifiers 510 is assumed to be 500 ns, and 648 amplifiers 510 corresponding to the case of 2K 2K are provided in each of the first data transfer line driving circuit 500A and the second data transfer line driving circuit 500B.

In the display device 1 of the present exemplary embodiment, the display unit 100 is equally divided into three display regions H1, H2, and H3 in the wiring direction of the scanning line 12, that is, in the X direction. That is, 3N÷3=N pixel circuits 110 are arranged in each row of the display regions H1, H2, and H3. As illustrated in FIG. 4, for the pixel circuits 110 belonging to the display region H1, one amplifier 510 is assigned to two pixel circuits 110 corresponding to the pixels of two dots adjacent to each other in the X direction, and for the pixel circuits 110 belonging to the display region H3, one amplifier 510 is also assigned to two pixel circuits 110 corresponding to the pixels of two dots adjacent to each other in the X direction. More specifically, for the pixel circuits 110 belonging to the display region H1 and the pixel circuits 110 belonging to the display region H3, two data transfer lines 14 for the two pixel circuits 110 corresponding to the pixels of two dots adjacent to each other in the X direction are connected to each other. In addition, one amplifier 510 is assigned to the two data transfer lines connected to each other, and the same gradation signal (for example, a gradation signal corresponding to the average of the display gradations of two dots adjacent to each other) is simultaneously applied. For example, the same gradation signal may indicate the average of display gradations of the pixels of two dots adjacent to each other.

More specifically, the data transfer line 14_2 which is an example of the second data transfer line, and the data transfer line 14_3 which is an example of a third data transfer line are connected, and the same gradation signal is applied to the data transfer line 14_2 and the data transfer line 14_3.

On the other hand, for the pixel circuits 110 belonging to the display region H2, one amplifier 510 is allocated for each column of the pixel circuits 110 (that is, for each data transfer line 14). Therefore, for each pixel circuit 110 belonging to the display region H2, a unique gradation signal generated based on the image signal Vid and the control signal Ctr2 is applied to each pixel circuit 110. For example, a gradation signal is applied to the central pixel circuit 110CP via the data transfer line 14_1, which is an example of the first data transfer line.

In other words, the data transfer line 14_1 is connected to the pixel circuit 110 belonging to the display region H2, and one amplifier 510 is provided for one data transfer line 14_1. Further, any one of the data transfer line 14_2 and the data transfer line 14_3 is connected to the pixel circuit 110 belonging to the display region H1, and one amplifier 510 is disposed corresponding to the two data transfer lines 14, that is, the data transfer line 14_2 and the data transfer line 14_3. Further, any one of the data transfer line 14_2 and the data transfer line 14_3 is connected to the pixel circuit 110 belonging to the display region H2, and one amplifier 510 is disposed corresponding to the two data transfer lines 14, that is, the data transfer line 14_2 and the data transfer line 14_3. In the display region H1, the number of amplifiers 510 included in each of the first data transfer line driving circuit 500A and the second data transfer line driving circuit 500B is smaller than the number of data transfer lines 14 connected to each of the first data transfer line driving circuit 500A and the second data transfer line driving circuit 500B. Similarly in the display region H3, the number of amplifiers 510 included in each of the first data transfer line driving circuit 500A and the second data transfer line driving circuit 500B is smaller than the number of data transfer lines 14 connected to each of the first data transfer line driving circuit 500A and the second data transfer line driving circuit 500B.

The vertical scanning frequency of the display device 1 is 90 Hz and M=3240, thus one horizontal scanning period is 1÷90÷3260=3.4 μs. Note that, the estimation of the writing time per pixel is set to 3260 instead of 3240 because the blanking period is considered to be 20 lines. The operation time of the amplifier 510 is 500 ns, thus the amplifier 510 can output six times in the period of 3.4 μs. N×3 pixel circuits 110 are arranged in the direction of the scanning line 12. Specifically, N is set to 2880. Here, in a case where writing column by column instead of writing two columns simultaneously, 2916×3÷6=1458 amplifiers 510 are required. Here, “2880” is calculated as “2916” in order to design with a slight margin to the screen standard size. Since half of the pixels of one row are driven by the first data transfer line driving circuit 500A (or the second data transfer line driving circuit 500B), in a case where only writing column by column is performed, 1458÷2=729 amplifiers 510 need to be provided in each of the first data transfer line driving circuit 500A and the second data transfer line driving circuit 500B. In the present exemplary embodiment, writing two columns simultaneously is performed for the display regions H1 and H3, thus the number of amplifiers 510 corresponding to the display regions H1 and H3 may be further halved, even if the number of amplifiers 510 corresponding to the display region H2 is taken into consideration, the number of amplifiers 510 required in the case of 2K 2K, that is, 648 amplifiers 510 is adaptable. The number of amplifiers in the case of 2K 2K is calculated by setting M=2160 and N=1920, and performing the calculation similar to the case of writing column by column.

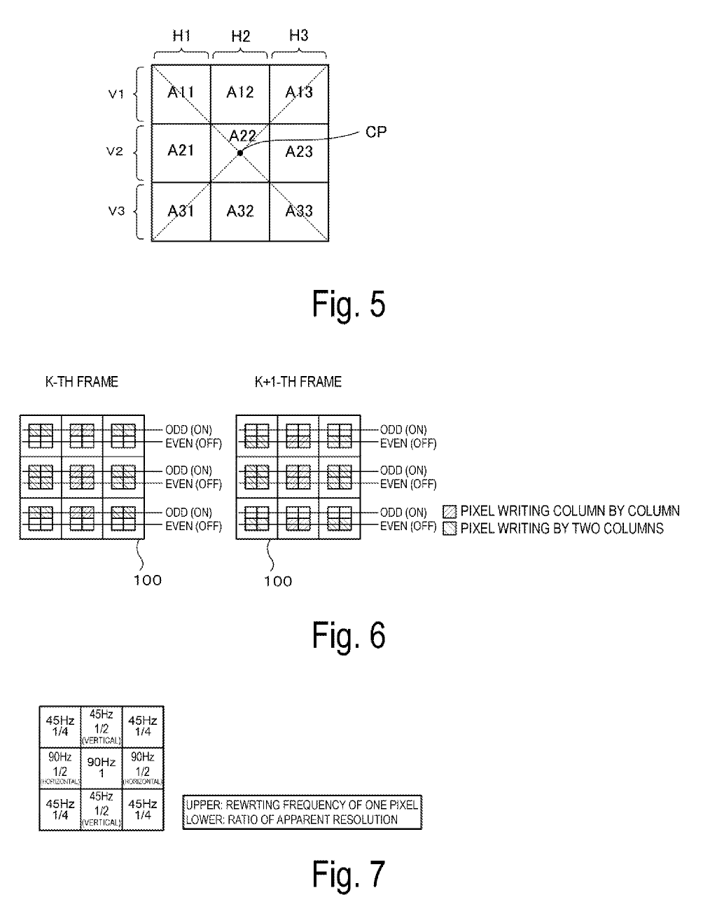

With this configuration, the display region of the display unit 100 is divided into nine display regions A11 to A33 as illustrated in FIG. 5. The pixel circuits 110 belonging to the display regions A11, A12, A13, A31, A32, and A33 are interlaced driven.

As illustrated in FIG. 6, in the display regions A11, A12, A13, A31, A32, and A33, for example, the display gradation of the dots belonging to the odd-numbered rows is updated in the k-th frame, and the display gradation of the dots belonging to the even-numbered rows is updated in the (k+1)-th frame. Then, for the display regions A11, A13, A31, and A33, the display gradation of the dots of the selected row is updated by two dots in each frame period, and for the display region A12 and the display region A32, the display gradation of the dots in the selected row is updated one dot by one. On the other hand, the display regions A21, A22, and A23 are display regions to be progressively driven. Therefore, for the display regions A21 and A23, the display gradation of the dots of all the rows is updated by two dots in each frame period, and for the display region A22, the display gradation is updated one dot by one.

As a result of this operation, as illustrated in FIG. 7, the rewriting period of the display gradation of the dots in the display regions A11, A12, A13, A31, A32, and A33 becomes 45 Hz, and the rewriting period of the display gradation of each dot in the display regions A21, A22, and A23 becomes 90 Hz. In other words, an apparent resolution in the Y direction of the display regions A11 and A31 becomes half of the apparent resolution in the Y direction of the display region A21. The apparent resolution in the Y direction is the resolution in which the rewriting period is added to the spatial resolution corresponding to the arrangement interval of the pixel circuits 110, that is, the resolution perceived by the user.

Similarly, the apparent resolution in the Y direction of the display regions A12 and A32 becomes half of the apparent resolution in the Y direction of the display region A22, and the apparent resolution in the Y direction of the display regions A13 and A33 becomes half of the apparent resolution in the Y direction of the display region A23. Further, in the display regions A11, A13, A21, A23, A31, and A33, the display gradation is updated by the simultaneous writing of two dots, thus, the resolution in the X direction of the display regions A11 and A13 becomes half of the resolution in the X direction of the display region A12. Similarly, the resolution in the X direction in the display regions A21 and A23 becomes half the resolution in the X direction of the display region A22, and the resolution in the X direction in the display regions A31 and A33 becomes half the resolution in the X direction of the display region A32. As a result, when the resolution of the display region A22 is set to p1, the apparent resolutions of the display regions A11, A12, A13, A21, A23, A31, A32, and A33 become ¼, ½, ¼, ½, ½, ¼, ½, ¼ respectively as illustrated in FIG. 7. As described above, in the display device 1 of the present exemplary embodiment, the resolution of the display region A22 to which the center CP of the display unit 100 belongs is higher than the resolution of the other eight peripheral display regions, thus when the user uses VR the resolution perceived by the user is high. The reason for this is as follows.

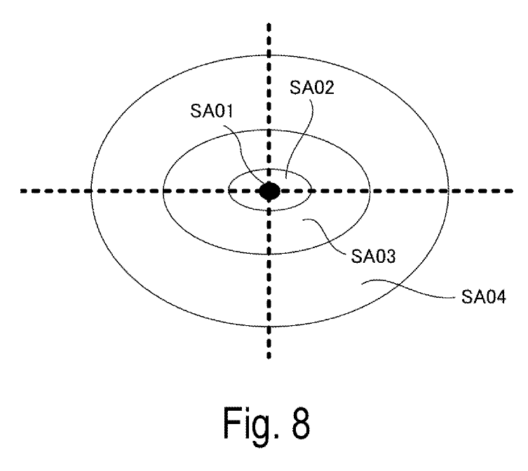

FIG. 8 is a diagram illustrating an example of visual field characteristics of human eyes. In FIG. 8, reference SA01 denotes discrimination visual field of a human, reference SA02 denotes an effective visual field, reference SA03 denotes an induction visual field, and reference SA04 denotes an auxiliary visual field, respectively. In the discrimination visual field, the visual function of vision and color discrimination is excellent, and advanced information can be received. The spread of the discrimination visual field is about 5°. In the effective visual field, the target information can be instantaneously received only by eye movement, and the spread of the effective visual field is about 30°. The induction visual field is the visual field that has low discrimination ability but may influence the direction sense, and has a spread from 30° to 100°. In the auxiliary visual field, the existence of visual information can be known, and the spread of the auxiliary visual field is from 100° to 200°.

In the display device 1 of the present exemplary embodiment, the resolution of the display region A22 that may correspond to the discrimination visual field SA01 of the user is the original resolution of 3K 3K, and the apparent resolution of other peripheral display regions is lower than the resolution of the display region A22. Specifically, for the display regions A12, A21, A23, and A32 which will correspond to the effective visual field SA02, the apparent resolution is half of the apparent resolution of the display region A22, and the apparent resolution of the display regions A11, A13, A31, and A33 which will correspond to the induction visual field SA03 is further halved. In a VR head-mounted display, the display image is updated with the detection of the movement of the head of the user as a trigger. That is, tracking processing is performed to switch the display image following the movement of the head of the user. For example, in a case where the user perceives a little uncomfortable feeling in the corner of the visual field and moves the head to see the direction with the uncomfortable feeling, a portion facing the face is updated to an image occupying the center with the detection of this movement as a trigger. Therefore, even if the apparent resolution of the other peripheral display region of the display region A22 is lowered, there is no significant influence on the resolution perceived by the user when the VR is used, and the resolution perceived by the user is high.

Further, according to the present exemplary embodiment, as compared to an aspect in which one set of the amplifier 510 and the switch 520 is allocated to each data transfer line 14, the number of amplifiers provided in the first data transfer line driving circuit 500A and the second data transfer line driving circuit 500B is reduced, and an increase in the circuit scale of the first data transfer line driving circuit 500A and the second data transfer line driving circuit 500B can be suppressed. Further, in the present exemplary embodiment, the pixel circuits of the display regions A11, A12, A13, A31, A32, and A33 are interlaced driven, the power consumption to a low level compared to a case where these pixel circuits are progressively driven can be suppressed.

Specifically, in order to implement 3K 3K resolution, 1458 amplifiers 510 were originally required, but according to the present exemplary embodiment, same 648 as in the case of implementing 2K 2K resolution is adaptable. As a result, the circuit scale occupied by the amplifiers 510 is reduced to 648/1458=1/2.25. The circuit area for the silicon substrate is reduced by about 7%. Further, with simultaneous driving of a plurality of columns, the amount of data required for driving the display unit 100 is also reduced to the same data amount as in the case of 2K 2K, the number of LVDS pairs used for transmission of these data is also reduced from 48 pairs originally required to 24 pairs, and the amount of current required for transmitting the data is also halved.

As described above, according to the display device 1 of the present exemplary embodiment, high definition while suppressing an increase in circuit scale and power consumption can be achieved. As another method for making the resolution of the display region A22 higher than the resolution of other peripheral display regions, it is conceivable to make the sizes of the light-emitting elements included in the pixel circuits 110 different between the display regions. Specifically, it is conceivable that, in the display region A22, the pixel circuits 110 including light-emitting elements smaller than the light-emitting elements included in the pixel circuits 110 arranged in the other regions, that is, the display regions A11 to A21 and A23 to A33, may be arranged at a higher density than the other display regions. However, in a display device using an OLED as a light-emitting element, the brightness of a pixel depends on the size of the light-emitting element. Therefore, in a case where the sizes of the light-emitting elements of the pixel circuits 110 belonging to each display region are different, the brightness between the display regions needs to be corrected. However, there are individual differences in the pixel circuits 110 and the luminance efficiency characteristics and the area relationships of each color of R, G, and B are not uniform, thus, it is very difficult to correct the brightness between the display regions. In the present exemplary embodiment, all of M×3N of the pixel circuits 110 include light-emitting elements having the same size. Therefore, according to this aspect, it is not necessary to correct the brightness between the display regions.

### B. Second Exemplary Embodiment

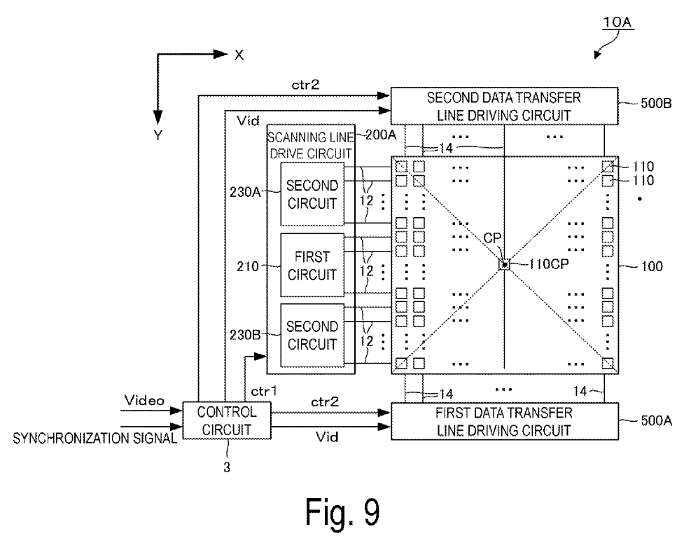

FIG. 9 illustrates a configuration example of a display panel 10A according to Second Exemplary Embodiment of the invention. In FIG. 9, the same components as those in FIG. 2 are denoted by the same references. As is apparent from comparing FIG. 9 and FIG. 2, the display panel 10A is different from the display panel 10A in that a scanning line driving circuit 200A is provided instead of the scanning line driving circuit 200. The configuration of the scanning line driving circuit 200A is different from the configuration of the scanning line driving circuit 200 in that a second circuit 230A is provided instead of the second circuit 220A, and a second circuit 230B is provided instead of the second circuit 220B. Hereinafter, the second circuit 230A and the second circuit 230B which are different from the first exemplary embodiment will be mainly described.

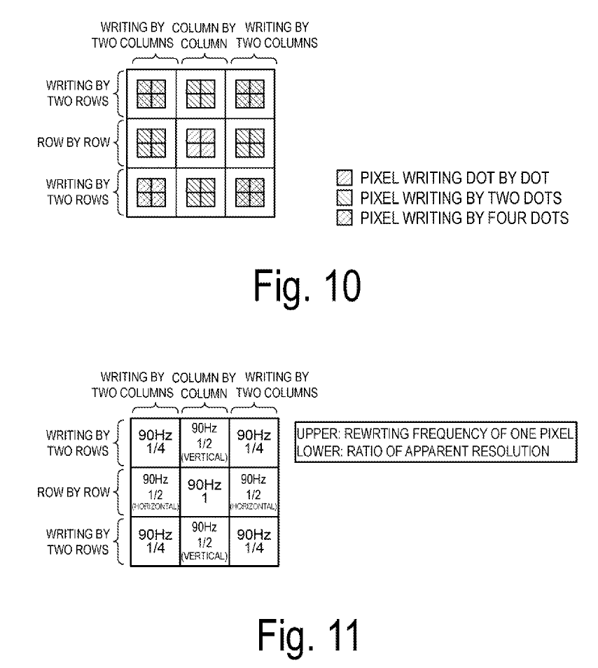

Similarly to the second circuit 220A according to First Exemplary Embodiment, 1080 scanning lines 12 from the top 1st to 1080th among the 3240 scanning lines 12 are connected to the second circuit 230A. Similarly to the second circuit 220B according to First Exemplary Embodiment, 1080 scanning lines 12 from the top 2161th to 3240th among 3240 scanning lines 12 are connected to the second circuit 230B. The second circuit 230A is a circuit that sequentially selects the 1st to 1080th scanning lines 12 two by two in order from the top during one frame period, and the second circuit 220B is a circuit that sequentially selects the 2161th to 3240th scanning lines 12 two by two in order from the top during one frame period. Therefore, as illustrated in FIG. 10, in a display device 1A according to the present exemplary embodiment, for the pixel circuits 110 belonging to the display region A12 and the display region A3 in FIG. 5, the display gradation is updated by two dots each time arranged in the column direction, and for the pixel circuits 110 belonging to each display region of the display regions A11, A13, A31, and A33 in FIG. 5, the display gradation is updated by four dots each time in total of two dots arranged in the column direction and two dots arranged in the row direction. Note that, for the two dots whose display gradation is updated at the same time, it may be updated to either of the two dots or the average display gradation of both, and for the four dots whose display gradation is updated at the same time, it may also be updated to any one of the four dots or the average display gradation of the four dots. In the present exemplary embodiment, a display region V2 composed of the display regions A21, A22, and A23 corresponds to a first display region for selecting the scanning lines 12 one by one. Further, a display region V1 composed of the display regions A11, A12, and A13 and a display region V3 composed of the display regions A31, A32, and A33 correspond to a second display region for selecting a plurality of scanning lines 12 at each time.

With this configuration, the rewriting frequency and the apparent resolution of one dot in each of the display regions A11 to A33 are as illustrated in FIG. 11. As illustrated in FIG. 11, also in the present exemplary embodiment, the resolution of the display region A22 is the original resolution of 3K 3K which is higher than the other peripheral display regions, and the resolution perceived by the user is high. According to the present exemplary embodiment as well, high definition of the display device while suppressing an increase in circuit scale can be achieved.

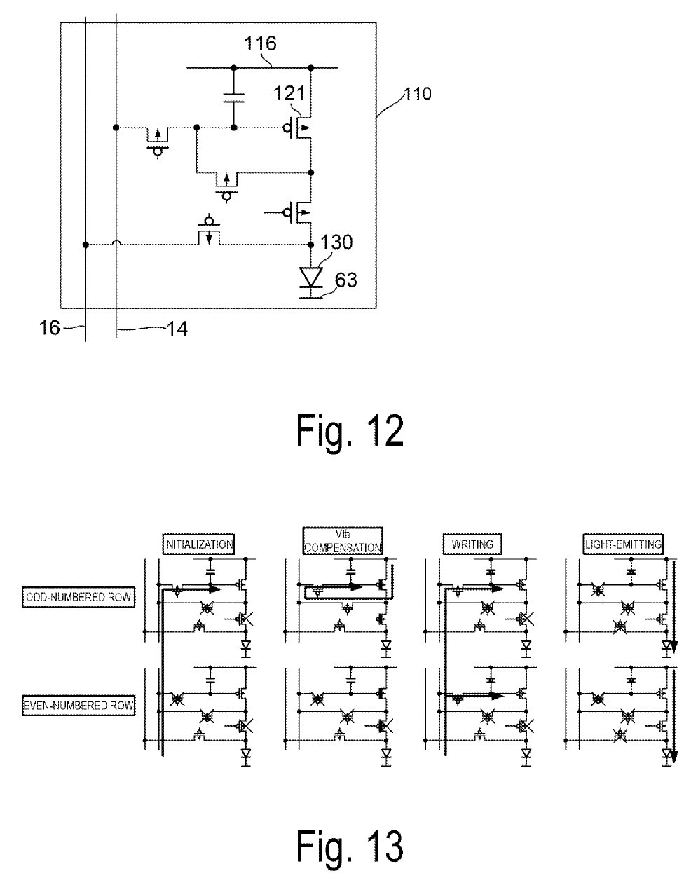

When the display gradations of the pixel circuits 110 of a plurality of rows are updated at the same time such as in the present exemplary embodiment, the pixel circuit 110 has the configuration illustrated in FIG. 12, and when it is desirable to perform the Vth compensation prior to updating the display gradation, Vth compensation may be performed only for the odd-numbered rows as illustrated in FIG. 13. Vth compensation refers to preventing occurrence of display unevenness due to a variation in the threshold voltage Vth of a driving transistor 121 that supplies a current corresponding to the display gradation to a light-emitting element 130. This is because the characteristics of the respective driving transistors 121 are assumed to be substantially equal between the pixel circuits 110 of odd-numbered rows and the pixel circuits 110 of even-numbered rows arranged in the display unit 100. Note that, in FIG. 12, reference numeral 16 denotes a power supply line that supplies a reset potential Vorst of the display panel 10, and reference numeral 116 denotes a power supply line that supplies a potential Vel which is a high side of the power source in the pixel circuit 110. Reference numeral 63 denotes a power supply line that supplies a potential Vct corresponding to the L level of the control signal.

### C. Modification Example

Although one exemplary embodiment of the invention has been described above, the following modification examples may be added to this exemplary embodiment.

(1) In each of the pixel circuits 110 of the second circuit 220A and 220B, the scanning lines 12 may be selected every plural lines such as every two or three lines and the like during each frame period. Similarly, in each of the second circuit 230A and the second circuit 230B, the scanning lines may be selected every three or more lines. Each of the second circuits 230A and 230B may be any circuit that selects a plurality of pixel circuits 110 arranged in a matrix on the display unit 100 in units of a plurality of rows. Further, in First Exemplary Embodiment and Second Exemplary Embodiment, the same gradation signal is applied to the data transfer lines 14 of two columns adjacent to each other for the second display region, but the same gradation signal may be applied to three or more data transfer lines 14 adjacent to each other.

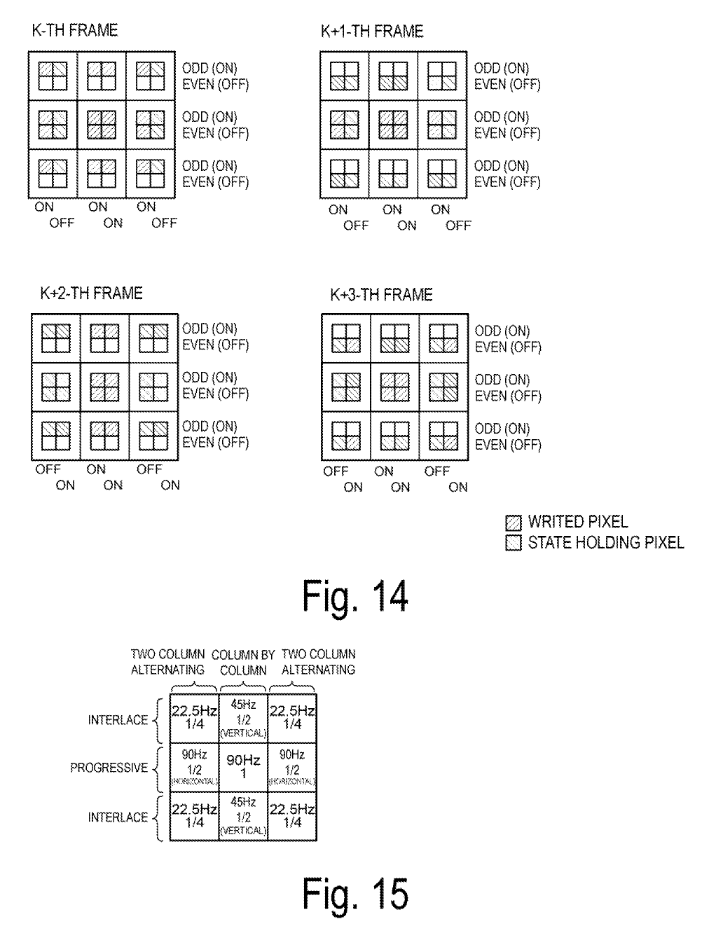

(2) In First Exemplary Embodiment and Second Exemplary Embodiment, for each of the display regions H1 and H3, the display gradation of the dots of the selected row is updated by two dots each time during one frame period, but these two dots may be alternately updated every two frame periods as illustrated in FIG. 14. However, in this aspect, even in the pixel circuit 110 which becomes an update target of the display gradation by selection of the scanning line, a pixel circuit having a function that can be turned OFF in the alternate update is necessary. It is necessary to add a switching transistor and a control signal in the pixel circuit. In order to update the display gradation of such a pixel circuit 110, past image data for four frames may be stored in the memory, and based on the stored data of the memory, the display gradation of a state holding pixel may be updated. According to this aspect as well, the resolution of the center of the display unit can be made higher than that of the periphery as illustrated in FIG. 15, while reducing the power consumption as compared with an aspect in which the entire display unit is driven normally, that is, an aspect in which scanning lines are selected row by row and display gradation is updated column by column.

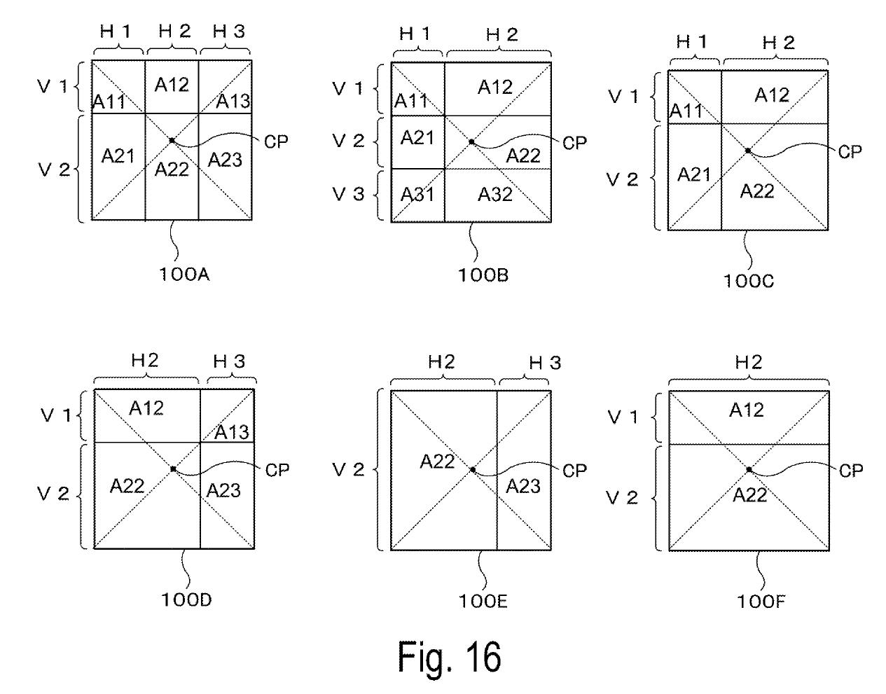

(3) In First Exemplary Embodiment and Second Exemplary Embodiment, the display region of the display unit 100 is divided into nine display regions in total of three equal parts in the row direction and three equal parts in the column direction. However, as in the display unit 100A in FIG. 16, the display region may be divided into six regions in total of three equal parts in the row direction and two parts in the column direction. In the display unit 100A in FIG. 16, the display region is divided in a manner that the ratio of the length in the column direction of the display region V1 to the display region V2 is 1:2, so as to make the resolution of the display region A22 including the center CP of the display unit 100A higher than the resolution of the peripheral display regions. In other words, in First Exemplary Embodiment and Second Exemplary Embodiment, the display regions A31, A32, and A33 may be omitted. Further, the area of the display region A21 may be different from the area of the display region A11, the area of the display region A22 may be different from the area of the display region A12, and the area of the display region A23 may be different from the area of the display region A13. Note that, the same applies to display units 100C, 100D, and 100F described later. Further, as in the display unit 100B in FIG. 16, the display region may be divided into six regions in total of two parts in the row direction and three equal parts in the column direction. In the display unit 100B in FIG. 16, in order to make the resolution of the display region A22 including the center CP of the display unit 100B higher than the resolution of the peripheral display regions, the ratio of the length in the row direction of the display region H1 to the display region H2 is 1:2. Note that, the same applies to the display unit 100C described later. In other words, in First Exemplary Embodiment and Second Exemplary Embodiment, the display regions A13, A23, and A33 may be omitted. Further, the area of the display region A12 may be different from the area of the display region A11, the area of the display region A22 may be different from the area of the display region A21, and the area of the display region A32 may be different from the area of the display region A31.

In addition, as in the display unit 100C in FIG. 16, the display region may be divided into four in total of two in the row direction and two in the column direction. In the display unit 100C in FIG. 16, in order to make the resolution in the display region A22 including the center CP of the display unit 100C higher than the peripheral display regions, the display region is divided such that the ratio of the length in the row direction of the display region H1 to the display region H2 is 1:2, and the ratio of the length in the column direction of the display region V1 to the display region V2 is 1:2. In other words, in First Exemplary Embodiment and Second Exemplary Embodiment, the display regions A13, A23, A31, A32, and A33 may be omitted. Further, the area of the display region A22 may be different from the area of the display region A11, or may be different from the area of the display region A12, or may be different from the area of the display region A13. The area of the display region A11 may be different from the area of the display region A12, or may be different from the area of the display region A21. Further, as in the display unit 100D in FIG. 16, the display region may be divided such that the ratio of the length in the row direction of the display region H2 to the display region H3 is 2:1, and the ratio of the length in the column direction of the display region V1 to the display region V2 is 1:2. In other words, in First Exemplary Embodiment and Second Exemplary Embodiment, the display regions A11, A21, A31, A32, and A33 may be omitted. Further, the area of the display region A22 may be different from the area of the display region A23, or may be different from the area of the display region A13, or may be different from the area of the display region A12. The area of the display region A13 may be different from the area of the display region A12, or may be different from the area of the display region A23. In the display unit 100C in FIG. 16, it is presumed that the display region A22 having a higher resolution than the other peripheral display regions extends from the vicinity of the center CP of the display unit 100 to the lower right, and is preferable to be used as a display unit for the left eye of the VR head-mounted display. Similarly, in the display unit 100D in FIG. 16, the display region A22 having a higher resolution than other peripheral display regions extends from the vicinity of the center CP of the display unit 100 to the lower left, and is preferable to be used as a display unit for the right eye of the VR head-mounted display. In the modification example, the display region V2 corresponds to a first display region for selecting the scanning line 12 one by one, and the display regions V1 and V3 correspond to a second display region for selecting the scanning line 12 every other line or every plural lines.

Further, as in the display unit 100E in FIG. 16, the display region may be divided into the display region H2 and the display region H3 only in the row direction without dividing the display region in the column direction. That is, the display device of the invention may satisfy the following three requirements. First, the display device includes a display unit that includes a pixel circuit disposed corresponding to the intersection of a first data transfer line and a scanning line, that is, a pixel circuit 110 belonging to the display region H2, a pixel circuit disposed corresponding to the intersection of a second data transfer line and a scanning line, that is, a pixel circuit 110 belonging to the display region H3, and a pixel circuit disposed corresponding to the intersection of a third data transfer line and a scanning line, that is, a pixel circuit 110 belonging to the display region H3 and adjacent to the pixel circuit 110 disposed corresponding to the intersection of the second data transfer line and the scanning line. Second, the display device further includes a driving circuit that selects the scanning line and applies a gradation signal indicating a display gradation to the first, second, and third data transfer lines. Third, the second data transfer line and the third data transfer line are connected, and the driving circuit applies the same gradation signal to the second and third data transfer lines. Even in any of the display units 100A to 100E illustrated in FIG. 16, as compared with an aspect in which the display gradation of the pixel circuits arranged on the matrix on the display unit are updated column by column, the circuit scale of the driving circuit for driving the pixel circuit can be reduced. Further, as in the display unit 100F in FIG. 16, the display region is not divided in the row direction but divided only in the column direction into the display region V2 and the display region V1, and the rewriting frequency of the display gradation of the pixel circuit belonging to the display region V1 may be lower than the rewriting frequency of the display gradation of the pixel circuit belonging to the display region V2. According to this aspect, as compared with an aspect in which the rewriting frequency of the display gradation of the pixel circuit belonging to the display region V1 and the rewrite frequency of the display gradation of the pixel circuit belonging to the display region V2 are the same, the power consumption can be reduced. Further, in a case where the pixel circuit at the center of the display unit belongs to the display region V2 and is disposed corresponding to the first data transfer line, the resolution at the center of the display unit becomes higher than the peripheral region, and is preferable to be used for the VR head-mounted display.

### D. Application Example

The display device according to the exemplary embodiment described above can be applied to various electronic apparatuses, and is particularly suitable for an electronic apparatus that is required to display an image with higher definition than 2K 2K and is required to be impact. Hereinafter, an electronic apparatus according to the invention will be described.

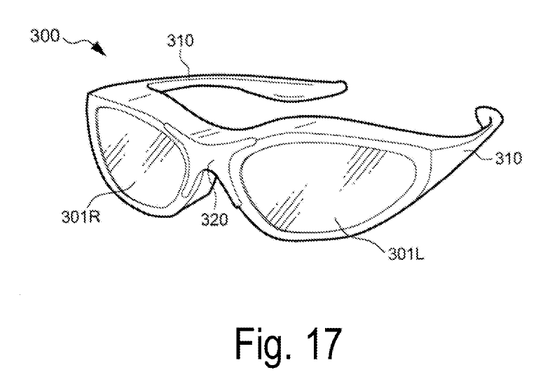

FIG. 17 is a perspective view of a head-mounted display 300 served as an electronic apparatus adopting the display device according to the invention. As illustrated in FIG. 17, the head-mounted display 300 includes a temple 310, a bridge 320, a projection optical system 301L, and a projection optical system 301R. In FIG. 17, a display device (not illustrated) for the left eye is provided behind the projection optical system 301L, and a display device (not illustrated) for the right eye is provided behind the projection optical system 301R.

Note that, examples of the electronic apparatus to which the display device 1 according to the invention is applied, in addition to the apparatus illustrated in FIG. 17, include an electronic device arranged close to the eyes such as a digital scope, a digital binocular, a digital still camera, and a video camera. The invention can also be applied as a display unit provided in an electronic apparatus such as a mobile phone, a smartphone, and a personal digital assistant (PDA).

The entire disclosure of Japanese Patent Application No. 2018-010419, filed Jan. 25, 2018 is expressly incorporated by reference herein.

What is claimed is:

1. A display device, comprising:
a display unit including pixel circuits disposed corresponding to each intersection of a plurality of scanning lines and a plurality of data transfer lines including a first data transfer line, a second data transfer line, and a third data transfer line; and
a driving circuit configured to select the plurality of scanning lines and apply a gradation signal indicating a display gradation to the first, second and third data transfer lines, wherein
the second and third data transfer lines are connected to each other, the driving circuit applies the same gradation signal to the second and third data transfer lines, and a pixel circuit at a center of the display unit is disposed corresponding to the first data transfer line.

2. The display device according to claim 1, wherein
the display unit is divided into a plurality of display regions including a first display region and a second display region in a wiring direction of the first data transfer line,
the first display region including first scanning lines of the plurality of scanning lines, and the second display region including second scanning lines of the plurality of scanning lines,
and
during a period required for displaying an image for one screen, the driving circuit selects the first scanning lines one by one for the first display region and selects the second scanning lines every other line or every other plural lines for the second display region.

3. The display device according to claim 1, wherein
the display unit is divided into a plurality of display regions including a first display region and a second display region in a wiring direction of the first data transfer line,
the first display region including first scanning lines of the plurality of scanning lines, and the second display region including second scanning lines of the plurality of scanning lines, and
during a period required for displaying an image for one screen, the driving circuit selects the first scanning lines one by one for the first display region and selects the second scanning lines at a time for the second display region.

4. The display device according to claim 2, wherein
the pixel circuit at the center of the display unit belongs to the first display region.

5. A display device, comprising:
a display unit that includes pixel circuits disposed corresponding to each intersection of a plurality of scanning lines and data transfer lines, and is divided into a plurality of display regions including a first display region and a second display region in a wiring direction of the data transfer line, the first display region including first scanning lines of the plurality of scanning lines, and the second display region including second scanning lines of the plurality of scanning lines; and
a driving circuit configured to, during a period required for displaying an image for one screen, select the first scanning lines one by one for the first display region, and select the second scanning lines every other line or every other plural lines for the second display region, and apply a gradation signal indicating a display gradation to the data transfer lines, wherein
a pixel circuit at a center of the display unit belongs to the first display region.

6. A display device, comprising:
a display unit that includes pixel circuits disposed corresponding to each intersection of a plurality of scanning lines and data transfer lines, and is divided into a plurality of display regions including a first display region and a second display region in a wiring direction of the data transfer line, the first display region including first scanning lines of the plurality of scanning lines, and the second display region including second scanning lines of the plurality of scanning lines; and
a driving circuit configured to, during a period required for displaying an image for one screen, select the first scanning lines one by one for the first display region, and select a plurality of the second scanning lines at a time for the second display region, and apply a gradation signal indicating a display gradation to the data transfer lines, wherein
a pixel circuit at a center of the display unit belongs to the first display region.

7. The display device according to claim 1, wherein
each of the pixel circuits includes a light-emitting element having the same size.

8. A display device, comprising:
a display unit including pixel circuits disposed corresponding to each intersection of a plurality of scanning lines and a plurality of data transfer lines including a first data transfer line, a second data transfer line, and a third data transfer line; and
a driving circuit configured to select the plurality of scanning lines and apply a gradation signal to the plurality of data transfer lines, wherein
the second and third data transfer lines are connected to each other.

9. An electronic apparatus comprising:
the display device according to claim 1.

10. An electronic apparatus comprising:
the display device according to claim 5.

11. An electronic apparatus comprising:
the display device according to claim 6.

12. An electronic apparatus comprising:
the display device according to claim 8.
